(19) United States
(12) Patent Application Publication
(10) Pub. No.: US 2017/0121821 A1
(43) Pub. Date: May 4, 2017

(54) NEW HIGH INDEX OXIDE FILMS AND METHODS FOR MAKING SAME

(71) Applicant: SBA Materials, Inc., San Jose, CA (US)

(72) Inventors: Mark L. F. Phillips, Albuquerque, NM (US); Khashayar Pakbaz, San Mateo, CA (US)

(73) Assignee: SBA Materials, Inc., San Jose, CA (US)

(21) Appl. No.: 15/317,663

(22) PCT Filed: Jun. 10, 2015
(86) PCT No.: PCT/US2015/035151

§ 371 Date: Dec. 9, 2016

Related U.S. Application Data
(60) Provisional application No. 62/010,416, filed on Jun. 10, 2014.

(51) Int. Cl. C23C 18/12; G02B 1/115

(52) U.S. Cl. CPC C23C 18/1254; C23C 18/1295; C23C 18/1212; G02B 1/115

(57) ABSTRACT

A method of preparing at least one layer of a multilayer dielectric (MLD) film stack by producing a sol from a mixture that comprises an epoxide and at least one precursor to a metal oxide, depositing the sol on a substrate, and preparing a metal oxide layer from the deposited sol. The mixture can also include one or any combination of a solvent, water, a precursor to a glassforming oxide, at least one modifier, a cosolvent, or a porogen. Two or more layers of the film stack can be prepared in similar fashion using the same or different sols.

### CROSS-REFERENCE TO RELATED APPLICATIONS

This application claims the benefit of U.S. Provisional Application No. 62/010,416, filed on Jun. 10, 2014, which is incorporated by reference herein in its entirety.

### BACKGROUND

Field of the Invention

This invention relates generally to dielectric oxide materials.

Related Art

Multilayer dielectric (MLD) films are commonly used to make antireflective coatings, mirrors, and optical filters. Such multilayer films can also be integrated as part of a light emitting device to enhance light outcoupling and/or shaping of the emission of the device both spectrally and physically, i.e., cone of emission or direction of emission. A simple one layer coating at quarter wavelength deposited on a glass substrate at an index lower than that of glass can be used an anti-reflection (AR) coating. Examples of such use include AR coatings on cover glass on photovoltaics cells to reduce the amount of reflected light and hence enhance module efficiency. By increasing the number of layers and through modeling to determine the index of each subsequent layer, more sophisticated coatings with <1% reflection loss over a wide range of angles can be created. In addition to AR coatings, such layers can be integrated into optical components for various applications and with different functionalities such as high reflectivity mirrors, optical filters with various transmission profiles etc. Designing such components requires a tool kit of optical coatings with a wide variety of indices and the ability to coat at different thicknesses. Although multi-layer sputtered coatings with different indices are in commercial use, creating high index coatings required to achieve the desired outcome as part of the multi-layer stack and doing so using low cost wet process techniques has proven very challenging.

### BRIEF SUMMARY

This invention provides a material and process for making sol-gel films with low absorption refractive index that is tunable index over a broad range (<1.2 to >2.2 in the visible spectrum). Thus, a new family of dielectric oxides and a new process for making these oxides via a solution chemistry route are provided. The process is applicable to making these materials in bulk objects or as films or fibers. The materials will find immediate application as thin (<10 μm) films. These films can be used in applications where a high refractive index or moderate index or low index combined with low absorption is desired. These materials can also be used as a binder for phosphor particles in waveshifting applications. A particular advantage of using this new set of dielectric materials is their low cure temperatures, which are in the range of 200-400° C.

Furthermore, use of liquid processes enables the ability to planarize and coat surfaces with certain geometries which cannot be easily achieved using traditional sputter or other vacuum process coatings where the coating process is by its nature conformal. For example, inter-digitated structures with different indices of refraction where one layer is patterned to created gaps in the layer and is backfilled and planarized by a second layer are possible. The ability to design a material system capable of delivering a wide index range, combined with liquid processing, enables the flexible design of low cost optical components with a wide variety of functionalities.

In one aspect, a method of making a metal oxide material is provided. The method includes a) producing a sol from a mixture that includes an epoxide and at least one precursor to a metal oxide, and b) preparing a metal oxide or composite oxide/organic material from the sol. The precursor can be a precursor to an oxide of any transition metal ion including a d° transition metal ion, and in particular embodiments, the precursor is a precursor to an oxide of Ti(IV), Zr(IV), Hf(IV), Nb(V), or Ta(V). The precursor can also be a precursor to an oxide of a main group metal such as Sn(IV), a lanthanide such as La(III) or Ce(III) or Ce(IV), or an actinide such as Th(IV). The precursor may be an alkoxide of the desired metal, or a metal salt, or a metal ion combined with an inorganic or organic ligand. In some embodiments, the sol can also include a precursor to a glassforming oxide. The glassforming oxide precursor can be an alkoxide or salt of a main group nonmetal such as B, Si, P, Ge, As, Se or Te. In some embodiments, the precursor can include a combination of two or more of the metal and/or glassforming oxide precursors, with the precursor combination including a transition metal, a main group metal, a lanthanide or actinide, or a main group nonmetal, or any combination thereof.

The mixture can further include one or more precursors to one or more additional metal oxides, also known as “modifiers”. In various embodiments, the one or more additional metal oxides or modifiers can be an oxide of: a divalent metal ion (such as Sr, Ba, Zn or Pb); a monovalent ion (such as Li, Na, Cs or Tl); a trivalent ion (such as Al or Ce(III) or Bi); or any combination thereof. The precursor to the modifier can be an alkoxide of the desired metal (including a transition metal), or a metal salt, or a metal ion combined with an inorganic or organic ligand.

With or without the precursors to the additional metal oxides, the mixture can also include a cosolvent, water, or a precursor to a glassforming oxide, or any combination thereof. Thus, in any embodiment comprising an epoxide, at least one metal oxide precursor, and a solvent, the mixture can also include at least one modifier, a cosolvent, water, or a precursor to a glassforming oxide, or any combination thereof. In particular embodiments, the glassforming oxide precursor can be an inorganic glassforming oxide precursor, or an organic glassforming oxide precursor. In certain embodiments the glassforming oxide is SiO₂, B₂O₃, P₂O₅, GeO₂, As₂O₃, SeO₂, or TeO₂. In some embodiments, the mixture can further include a porogen, which can be a surfactant. The mixture can thus comprise any combination, and in any amount or range of amounts, of the epoxide, precursor to a metal oxide, solvent, cosolvent, modifier, water, precursor to a glassforming oxide, and porogen, as described herein.

In various aspects, the method can provide: material including a metal oxide or a mixture of metal and nonmetal oxides including a glassy phase, or a metal oxide material that includes nano-scale grains of crystalline oxide surrounded by a glassy phase analogous in structure to the mineral opal.

It is possible to tune the refractive index of the metal oxide material depending on the composition of the sol-producing mixture. Thus, a metal oxide material having a particular preselected refractive index can be obtained. In some embodiments, the metal oxide material can have a refractive index n of about 1.45 to about 2.6. When the material includes a glassy phase that includes a metal oxide or a mixture of metal and nonmetal oxides, the material can have a tunable refractive index. In embodiments containing a porogen, the metal oxide material is made porous.

The metal oxide material can be in the form of a thin layer film, a paste, a monolith, or a fiber. In addition, in various embodiments the metal oxide material can be prepared by spin-, dip-, roll-, draw-, or spray-coating; or by means of a printing technique; or by casting a monolith; or by drawing fibers. The metal oxide material can also serve as a binder phase for powders or grains of another material.

In particular embodiments, the metal oxide material comprises an oxide of: Ti(IV), Zr(IV), Hf(IV), Nb(V), Ta(V); a divalent metal ion (such as Sr, Ba, or Pb); a monovalent ion (such as Li, Na, or Tl); a trivalent ion (such as Al, Ce or Bi); or a combination thereof.

In another aspect, a sol prepared by any of the methods described herein is provided. Also provided is any dried film produced from the sol by applying the sol to a surface and then drying the applied sol. Any film produced from the dried film by baking the dried film so as to drive off solvent is further provided, as is any annealed film produced from the dried film by annealing the dried film at a temperature in the range of about 200° C. to 800° C. In various embodiments, the annealed film can be amorphous or can be partially crystalline.

In another aspect, any metal oxide material prepared according to the methods described herein is provided.

A film prepared from the sol can include a metal oxide or a mixture of metal and nonmetal oxides comprising a glassy phase, or can include nano-scale grains of crystalline oxide surrounded by a glassy phase. In some embodiments, the film has a refractive index n of about 1.45 to about 2.6. The film can be in the form of a thin layer film, a paste, a monolith, or a fiber, and can be prepared by spin-, dip-, roll-, draw-, or spray-coating, or by means of a printing technique, or by casting a monolith, or by drawing fibers. In some embodiments, the film can have a dielectric constant in the range of 1.7 to 1.9 (which can be a dielectric constant of 1.8 in some embodiments) and have a thickness of approximately 100 nm.

In some embodiments, the film can be used as an antireflective coating or a mirror.

In some embodiments, the metal oxide material forms a layer of a multilayer dielectric (MLD) film stack. Thus, another embodiment is a method of making an MLD film stack by forming the metal oxide material as a layer of an MLD film. In this embodiment, the method includes producing a sol from a mixture that comprises an epoxide and at least one precursor to a metal oxide, depositing the sol on a substrate, and preparing a metal oxide layer from the deposited sol. The at least one precursor can be: an alkoxide or salt of a transition metal, or is a transition metal ion combined with an inorganic or organic ligand; an alkoxide or salt of a main group metal; or an alkoxide or salt of a lanthanide or actinide. In some embodiments, the mixture further includes an alkoxide or salt of a main group nonmetal selected from the group consisting of B, Si, P, Ge, As, Se, and Te. In some embodiments, the at least one precursor includes two or more metal oxide precursors. In some embodiments, the at least one precursor includes a transition metal, a main group metal, a lanthanide, an actinide, or a combination thereof, and the mixture further includes a main group nonmetal.

In some embodiments of the MLD method, the mixture can further include a solvent, water, a precursor to a glassforming oxide, at least one modifier, a cosolvent, or a porogen, or a combination thereof. The modifier can be an alkoxide or salt of a transition metal, can be a transition metal ion combined with an inorganic or organic ligand, or can be a combination thereof. The glassforming oxide can be SiO₂, B₂O₃, P₂O₅, GeO₂, As₂O₃, SeO₂, or TeO₂.

In some embodiments of the MLD method, the metal oxide layer includes a metal oxide or a mixture of metal and nonmetal oxides comprising a glassy phase, or nano-scale grains of crystalline oxide surrounded by a glassy phase. The glassy phase can include a metal oxide or mixture of metal and nonmetal oxides forming a material having a preselected refractive index.

In some embodiments of the MLD method, the metal oxide layer can have a refractive index n of about 1.45 to about 2.6, a dielectric constant in the range of 1.7 to 1.9, and a thickness of approximately 100 nm, or any combination thereof. In some embodiments, the dielectric constant is 1.8. In embodiments containing a porogen, the metal oxide layer can be made porous.

An MLD film stack can include two or more metal oxide layers that are prepared by the methods described herein. In such embodiments, a sol can be deposited over a previously formed metal oxide layer. The sol for preparing one layer can be the same or different from the sol for preparing another layer. By varying the thickness and composition of the different layers, MLD film stacks having different reflective properties can be produced.

An MLD film stack can be used, for example, as an antireflective coating, a mirror, a light outcoupling layer to improve brightness, or a light steering layer to change the emission cone or direction of emission of light. Such layers can be integrated within the device or along the light path away from the source of the emission of the photons. For example, the MLD film stack can be used as a reflective element in a light emitting device, such as an organic light emitting diode, light emitting diode, or LCD display, to enhance the light output or redirect the light output angle. Thus, some embodiments include a light emitting device comprising an MLD film containing one or more metal oxide layers prepared by any of the MLD methods described herein.

### BRIEF DESCRIPTION OF THE DRAWINGS

For a more complete understanding of the present invention, reference is now made to the following descriptions taken in conjunction with the accompanying drawings, in which:

FIGS. 1A-1D are schematic drawings of MLD film stacks in various devices;

FIG. 2 is an I-V plot of a Ta₂O₅:GeO₂ film, where T_{OX}=115 nm, and κ=90;

FIG. 3 is a graph showing optical dispersion curves for two high n films and one n˜1.5 film with high Abbe number;

FIG. 4 is a graph showing the optical dispersion curve of a high-index film composed of a titanium alkoxide and glycidol, spun and dried at 295° K;

FIGS. 5A-5H are parts of a table listing the compositions of films; and

FIGS. 6A-6H are parts of a table listing the properties of films.

### DETAILED DESCRIPTION

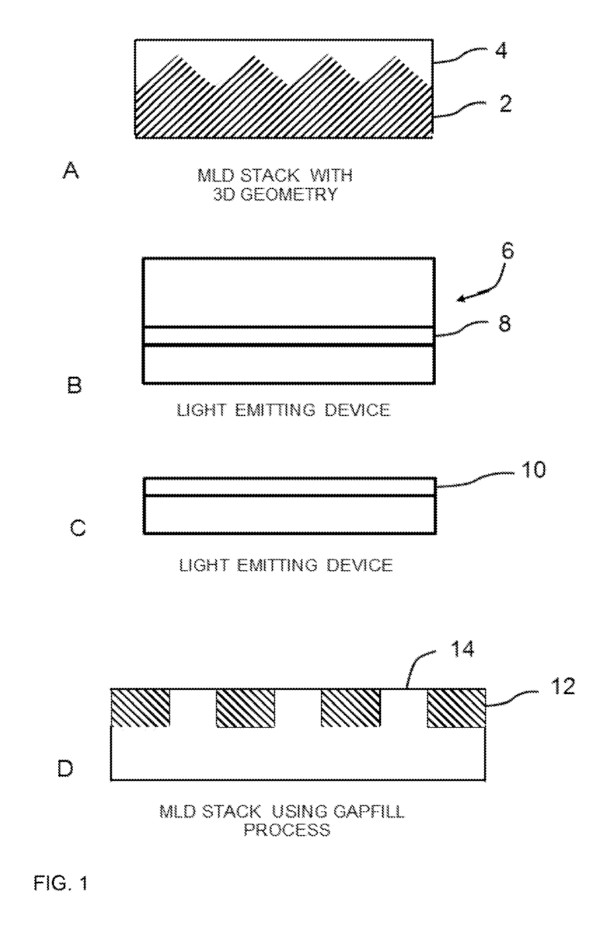

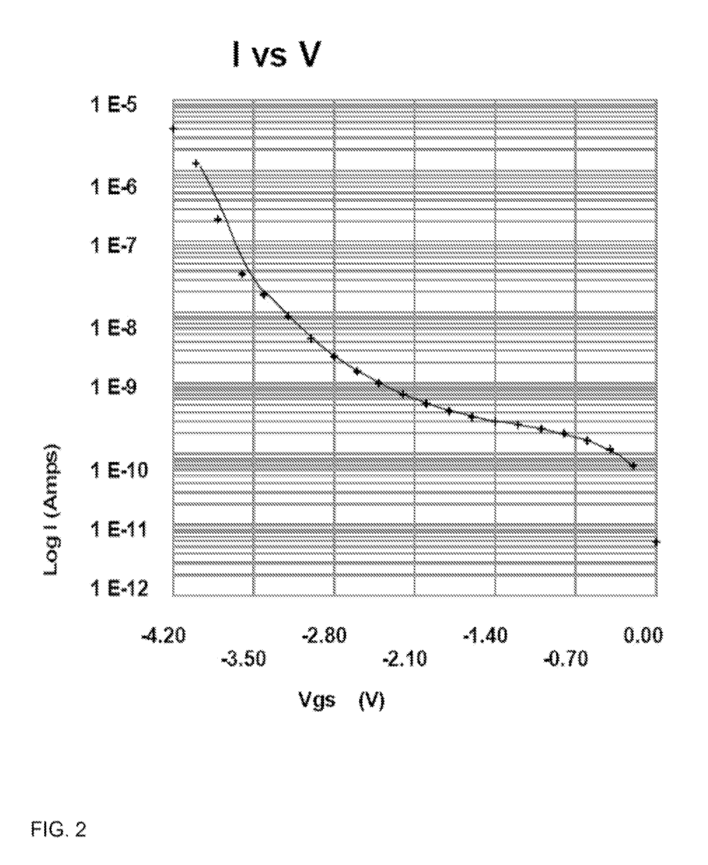

In some embodiments, a metal oxide material can form a layer of a multilayer dielectric (MLD) film stack. Referring to FIG. 1A, a first dielectric 2 and a second dielectric 4 is included in an MLD film stack having a 3D geometry. To make this stack, a layer can be deposited and patterned either using subtractive techniques such as photolithography or stamping techniques. A second layer can be coated on the patterned layer by a liquid process such as spin coating or slot coating. As a result, the second coating gapfills and planarizes the first layer. Also shown in the figure is a light emitting device 6 having an MLD film stack 8 in FIG. 1B, and another light emitting device having an MLD film stack 10 in FIG. 1C. Another embodiment is an MLD film stack prepared by a gapfilling process containing a material 12 having one refractive index and a material 14 having another refractive index, as shown in FIG. 1D.

In various embodiments, films (including films forming a layer of an MLD film stack) and other structures in accordance herein generically include metal ions with a d⁰ or d¹⁰ electronic configuration in combination with a main group “glassformer” oxide such as SiO₂. For optical materials with refractive indices at visible wavelengths in excess of ˜1.6, these ions can be d⁰ transition metal ions such as Ti(IV), Zr(IV), Hf(IV), Nb(V), and Ta(V), or main group d¹⁰ ions such as Sn(II), Sn(IV), Sb(V) or Bi(III). They can also be lanthanide or actinide ions, preferably those without absorption at desired wavelengths of operation. For the visible spectrum these ions include La(III), Ce(III), Ce(IV), Gd(III), Lu(III), Th(IV) and others. These ions are used individually or in combination with one or more modifier ions, which are typically a divalent metal ion such as Sr, Ba, Zn or Pb, but can also be monovalent (e.g., Li, Na, Cs, Tl) or trivalent (e.g., Al, Ce, Bi), or any combination thereof. Metal ions can also be used in combination with main group “glassformer” nonmetal oxides such as SiO₂, B₂O₃, P₂O₅, GeO₂, As₂O₃, and TeO₂.

The modifier ion can be an ion of any alkali metal, alkaline earth metal, lanthanide, actinide, or main group metal (such as, Al, Ga, In, Sn, Sb, Tl, Pb, or Bi)

Films and other structures can be made via a process that uses a derivative of traditional sol-gel chemistry in which the source of the metal oxide can be a salt or an alkoxides. The principal distinction between the formulation described herein and previously known sol-gel formulations is the inclusion of an epoxide moiety, in some embodiments with a cosolvent that contains the epoxide moiety. This has the effect of creating gel-forming sols from metal salts (which would otherwise reconstitute as solid salts when dried or deposited). Inclusion of the epoxide moiety additionally improves upon traditional sol-gel chemistry by allowing inclusion of higher concentrations of water into formulations that use metal alkoxides without inducing precipitation or excessively rapid gelation. The result is higher quality films that can be spun uniformly onto substrates as large as 300 mm diameter, and thicker films (300 nm-10 um) that are less susceptible to leakage.

In various embodiments, an effective strategy for synthesizing high refractive index (high n) films (or bulk glass) is to combine a transition metal or main group ion known for high index (high n) as the oxide (e.g., Ti(IV) or Sn(IV)) with a high index glassformer ion such as GeO₂ or TeO₂. The low glass transition temperatures (Tg) typical of TeO₂ glasses render this platform very useful for applications requiring a low anneal or reflow temperature. A heavy metal modifier ion such as Ba²⁺, Tl⁺, and/or Pb²⁺ can additionally stabilize the film, lower Tg, and increase refractive index. Such optical films are useful in multilayer dielectric films that function as antireflective coatings or mirrors, and have applications in displays, architectural glass, digital imaging and telecom components.

An embodiment for making the high n oxides described herein starts with a sol dispersed in an organic liquid, which is then applied to a substrate and thermally cured. The sol includes the following:
1. A precursor to at least 1 metal oxide. The precursor can be, but is not limited to, a metal alkoxide, salt, or chelate. The only requirement is that the precursor is soluble in the desired solvent (see below).
2. A solvent such as, but not limited to, an alcohol like methanol, or a glycol ether like 2-methoxyethanol. Certain metals benefit from stabilization with carboxylic acids such as acetic acid, or beta-diketonates such as ethyl acetoacetate. In general, the solvent should be compatible with the metal ion(s) in solution and furthermore produce a sol that performs well with the deposition process desired. These characteristics of the solvent are generally determined empirically. Low molecular weight alcohols, ethers, and glycol ethers can be good solvent candidates.
3. An epoxide such as oxirane, propylene oxide, butadiene diepoxide, glycidyl isopropyl ether, etc.

The sol may optionally include any combination of the following:
4. A cosolvent, typically with a lower evaporation rate than the solvent in (2). Cosolvents can typically be selected from higher molecular weight glycol ethers such as diglyme or dipropylene glycol monomethyl ether. Other chemistries (e.g., Freons) may be preferred depending on the metal ion that is being stabilized.
5. One or more additional metal oxide precursors as salts, alkoxides, chelates, or the like.
6. Water, which can be added as liquid H₂O or as water of crystallization if hydrated metal salts are used.
7. A precursor to a nonmetallic glassforming oxide such as SiO₂, B₂O₃, P₂O₅, GeO₂, As₂O₃, SeO₂, or TeO₂.
8. A porogen, which may be a surfactant or blowing agent, which is added to increase the porosity and thus lower the refractive index of the resulting film.

The addition of a porogen may seem counterintuitive, especially if the objective is to make films of moderate index (1.5-1.9) or high index (1.9 to 2.3). However, it is frequently convenient to use porogens to tune a composition to yield a desired index by starting with a higher index and incrementally reducing it by introducing porosity. In some embodiments, the porogen is a polymer surfactant. This is typically an amphiphilic block copolymer incorporating hydrophilic (e.g., polyethylene oxide) and hydrophobic (e.g., alkyl chains or polypropylene oxide) regions. Examples include, but are not limited to, triblock copolymer surfactants that are poly(ethylene oxide)-poly(alkylene oxide)-poly(ethylene oxide) polymers where the alkylene oxide moiety has at least three carbon atoms. These would include poly(ethylene oxide)-polypropylene oxide)-poly(ethylene oxide) polymers such as BASF Pluronic P104. Other polymer surfactants that are effective include polyoxyethylene alkyl ethers such as Brij; in some embodiments, the polymer surfactant is polyethylene glycol (n˜20) octadecyl ether (PEG-20 stearate). Other examples of amphiphilic copolymer surfactants are the amphiphilic copolymers described in Stucky et al. U.S. Pat. No. 7,176,245, which is incorporated by reference herein. In particular embodiments, the surfactant is electrically neutral and decomposes at a low temperature such as 250° C.-500° C. A surfactant can be included at concentrations from 2-10% w/v, with typical concentrations varying from 4-9%.

Other examples of metal oxide precursors, epoxides, solvents, and glassforming oxide precursors are described in U.S. Patent Publication No. 2010/0311564 of Phillips, which is incorporated by reference herein.

It is understood that a general principle for making MLD optical films is to combine alternating layers of low and high refractive index films. This can of course be accomplished with layers of low index (1.1 to 1.4) films with moderate index films. In some cases it is desirable to make these films of similar materials, using porogens to reduce the index of the low index film. This may be advantageous in making MLD films with temperature stable reflectance spectra, since dn/dT values for the high and low index films will be similar.

In some embodiments, all components of the sol recipe are added as liquids. The metal and glassformer oxide precursors may themselves be solids or liquids at ambient temperature; they are nonetheless mixed with an organic solvent prior to being combined with the other ingredients. These ingredients can be combined in an order that is particular to the oxide precursors involved, and examples are provided below.

Once mixed the sol may be deposited onto a substrate by spin-, dip-, roll-, draw-, or spray-coating, or by using a printing technique such as inkjet, gravure, screen, or stencil printing, or by other means known in the art. It is also possible to cast monoliths or draw fibers from the sol. Depending on the pot life of the particular sol, it may be desired to deposit the material immediately, or the material may be stored and used at a later date.

Once deposited, the sol is dried to produce an amorphous film. Drying can occur at ambient temperature or at elevated temperature, typically at a temperature in the range of about 50° C. to 200° C., or any temperature or temperature sub-range falling in such range. Depending on the application the film may also be annealed, typically at a temperature from about 200° C. to 800° C., or any temperature or temperature sub-range falling in such range. The resulting film can be amorphous, partially crystalline, or completely crystalline. In certain applications it is advantageous to have a partially crystalline or amorphous film since such a film may exhibit less optical absorption, haze or scatter. If the sol includes a polymer surfactant as a porogen, a porous film is produced, with the annealing decomposing the surfactant.

The range of epoxides that are useful are not limited to the examples listed above. Other epoxides that can be used include but are not limited to ethyl oxirane, 1,2 dimethyl oxirane, epichlorohydrin, glycidol, glycidal, glycidyl ethers including glycidyl methyl ether, diglycidyl ether, ethylene glycol diglycidyl ether, glycidyltriethoxysilane, or other epoxides and derivatives thereof.

In addition, the anneal temperatures used in the examples should not be taken as limiting cases. It is possible with many compositions to use higher annealing temperatures to obtain improved or desired properties, or if shorter anneal times are desired. Lower anneal temperatures are also available, particularly if combined with UV illumination or cathode ray irradiation. This may be particularly useful if dielectric oxide films are to be applied to thermally sensitive substrates such as plastic, copper or steel. Further, atmospheres other than air may be used to improve performance or to prevent damage to the substrate or other components.

### EXAMPLES

### Example 1

Ta₂O₅:GeO₂ film: 1 g of a 1 mol/L solution of tantalum (V) ethoxide in 2-ethoxyethanol was combined with 0.2 g of a 1 mol/L solution of germanium isopropoxide in 1-methoxy-2-propanol and 1 g glycidol. After a few minutes, 0.5 g of a 10 mol/L solution of H₂O in 1-methoxy-2-propanol was added dropwise with agitation. This sol was then spun onto a Si wafer at 1500 rpm for 1 min. After a soft bake at 140° C. for 5 min., the chip was annealed for 60 min. at 600° C. The resulting film was optically clear, with a T_{OX} of approximately 115 nm. The dielectric constant κ at 1 Mhz was 90, and the loss τ was 25%.

FIG. 2 shows a current vs. voltage (I-V) plot of a resulting Ta₂O₅:GeO₂ film, where T_{OX}=115 nm, and is κ=90.

### Example 2

Bi₂O₃.ZrO₂.TiO₂.GeO₂ film: 1 g of a 1 mol/L solution of Bi(NO₃)₃ in 1:1 acetic acid/2-ethoxyethanol was added dropwise to 2 g glycidol with agitation. To this solution 0.48 g 1 mol/L titanium isopropoxide, 0.52 g 1 mol/L zirconium n-propoxide, and 0.2 g germanium isopropoxide, all in 1-methoxy-2 propanol, were added. This sol was then spun onto a Si wafer at 1000 rpm for 1 min. After a soft bake at 140° C. for 5 min., the chip was annealed for 60 min. at 400° C. The resulting film was optically clear with a thickness of approximately 145 nm. κ was 88, and the loss τ was 20%.

### Example 3

BaO.TiO₂.TeO₂ film: A solution containing 0.5 g each 2-(2-ethoxy)ethoxyethanol) and propylene oxide was prepared. To this solution 0.35 g 1 mol/L titanium isopropoxide in 1-methoxy-2 propanol was added. 0.2 g 0.5 mol/L TeBr4 in 2-methoxyethanol was added dropwise with agitation, followed by 0.2 g Ba(ClO₄)₂, 1 mol/L in methanol. This sol was then spun onto a Pt-coated Si wafer at 1000 rpm for 1 min. After a soft bake at 140° C. for 5 min., the chip was annealed for 30 min. at 400° C. The resulting film was optically clear, with a thickness of approx. 140 nm. κ was 40, and the loss τ was 1.8%.

### Example 4

SiO₂.Al₂O₃.ThO₂ film: 1 g of a 1 mol/L solution of Al(NO₃)₃.9H₂O in 2-methoxyethanol was added dropwise to 2 g glycidol with agitation. This was followed by 1 g neat methyltriethoxysilane and 0.5 g of a 1 mol/L Th(NO₃)₄ solution in methanol. This sol was then spun onto a Si wafer at 1000 rpm for 1 min. After a soft bake at 140° C. for 5 min., the chip was annealed in air for 10 min. at 400° C. The resulting film had a T_{OX} of about 570 nm and an Abbe number of 46.5.

### Example 5

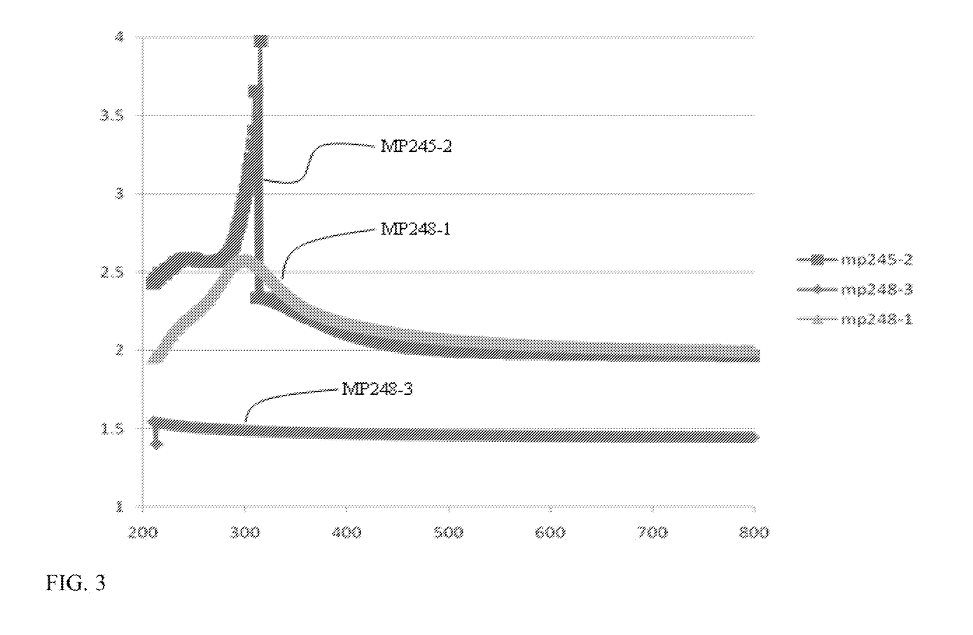

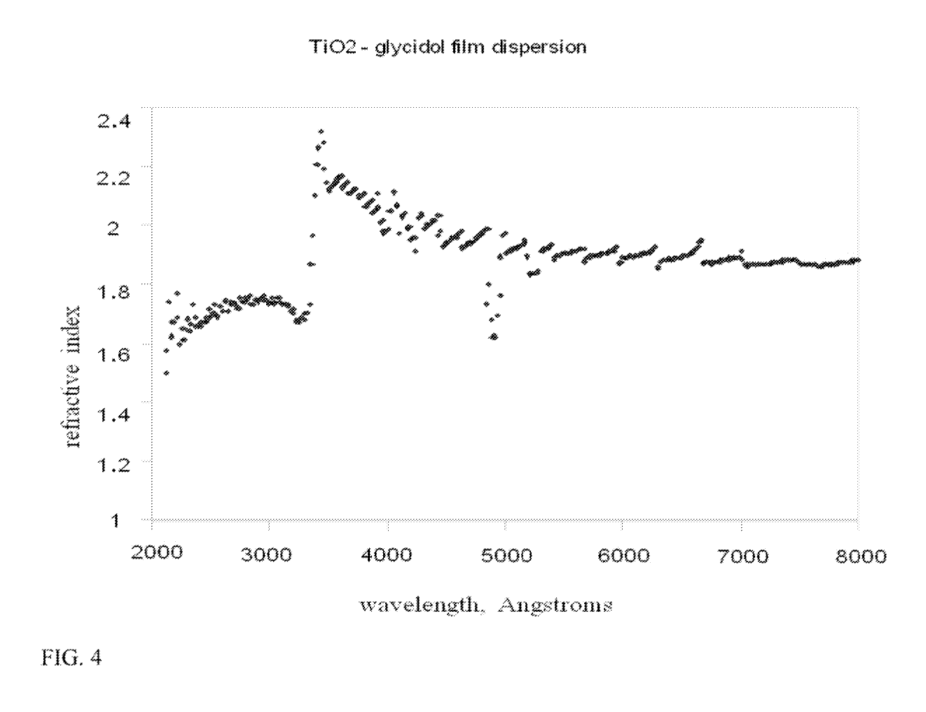

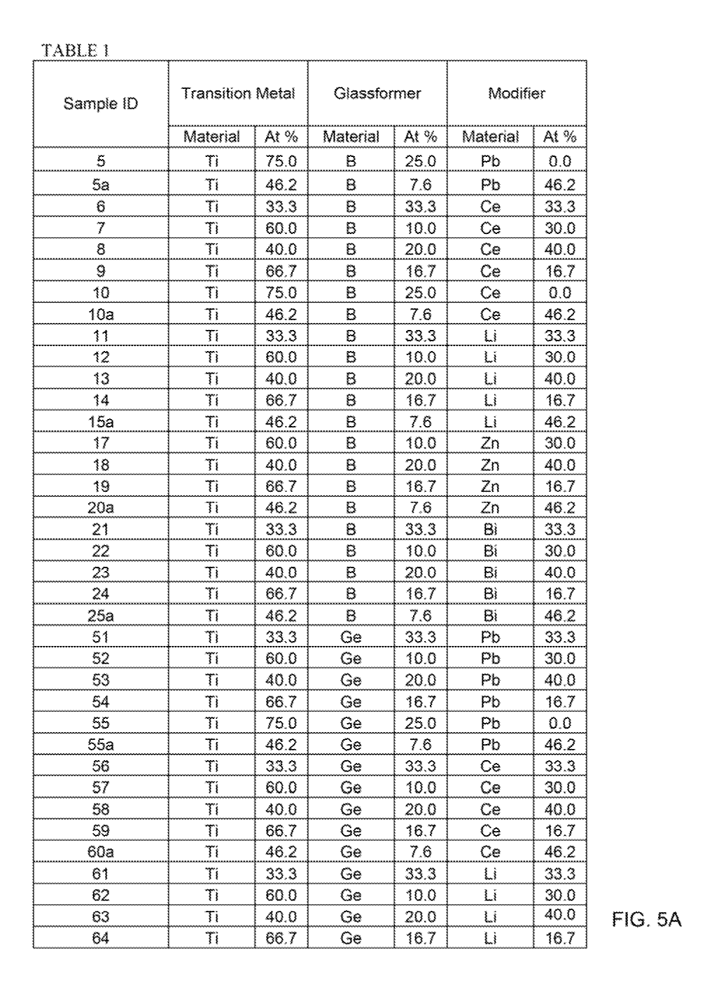

FIG. 3 shows optical dispersion curves for three test films made via the synthetic processes described herein. Film mp245-2 was prepared as in Example 2, above. Film mp248-1 was made using the process described in Example 3, above, except that it was coated onto a bare Si wafer. Film mp 248-3 was made as in Example 4.

It should be apparent that this technique is applicable to synthesizing any number of optical glass compositions, many of which, like the films shown in FIG. 3, are difficult to impossible to prepare using conventional glassmaking methods.

### Example 6

11.7 g titanium isopropoxide (97%) is combined with 1-methoxy-2-propanol to make a solution containing 1.5 mmol Ti per gram of solution. Next, 4.93 g glycidol (96%) is added with stirring, followed by 0.5 g of a solution made by combining 3.6 g H₂O and 16.4 g 1-methoxy-2-propanol. After 1 day, 10 g of the resulting sol is mixed with 4 g 2-(2-ethoxy)ethoxyethanol. This solution may be dispensed via spin, dip, or spray coating to yield a coating that dries to a film about 1-3 um thick at room temperature. The dispersion curve of this high-index film is shown in FIG. 4.

### Example 7

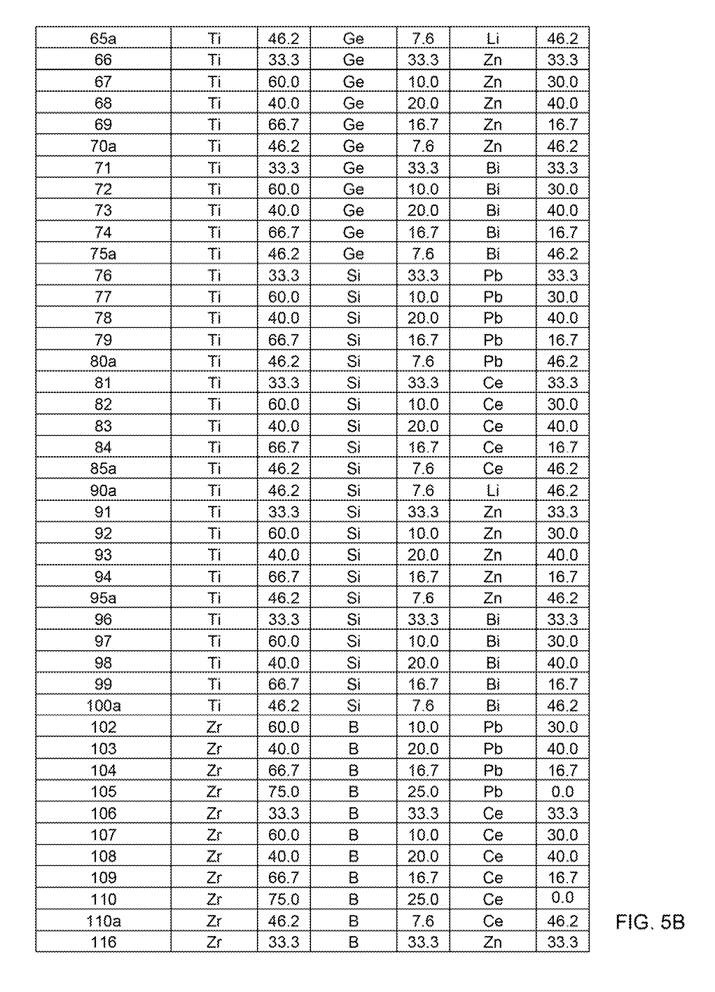

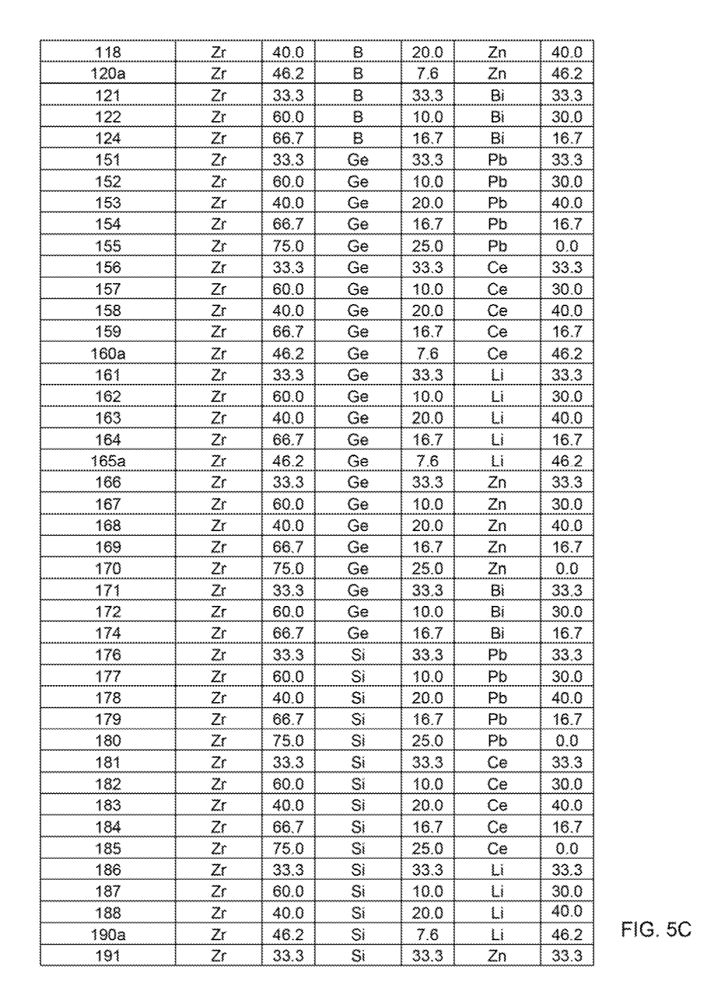

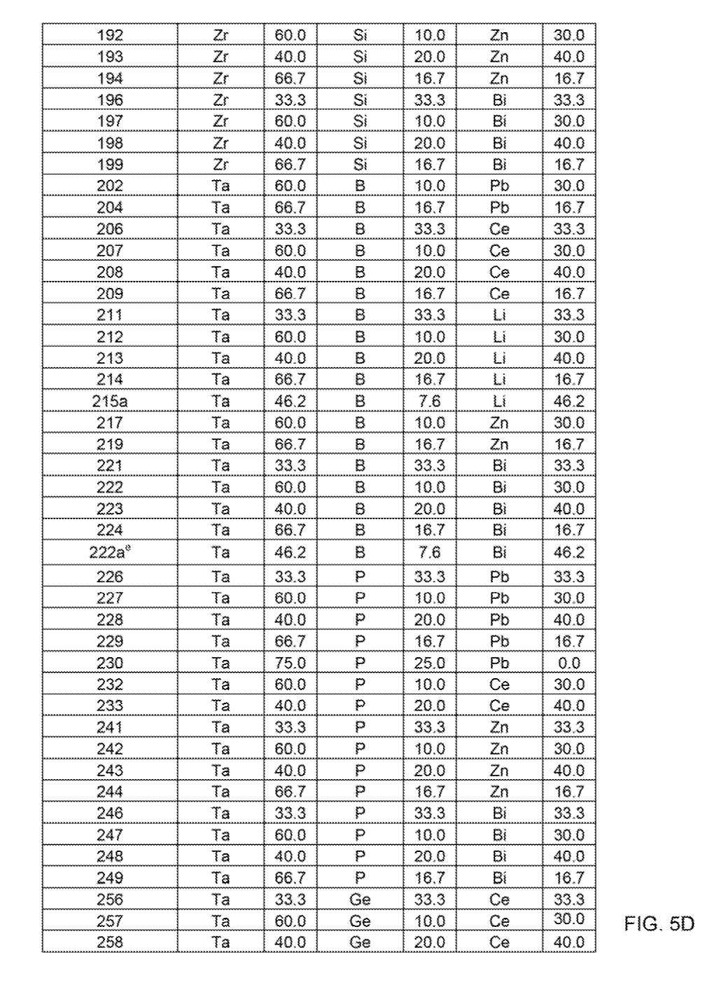

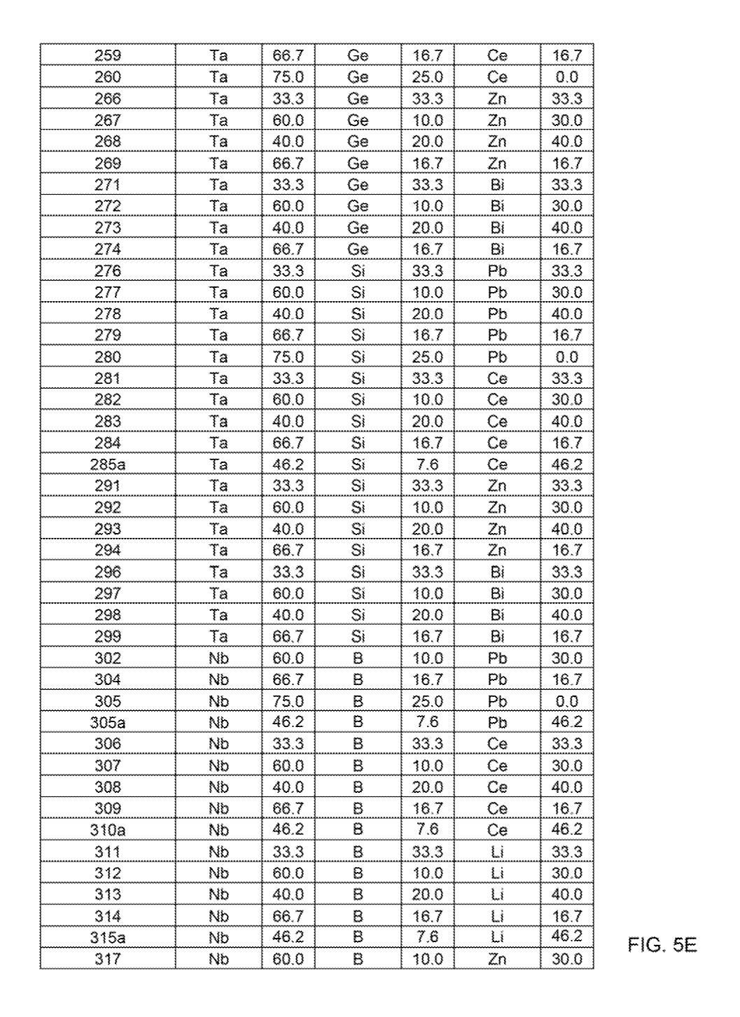

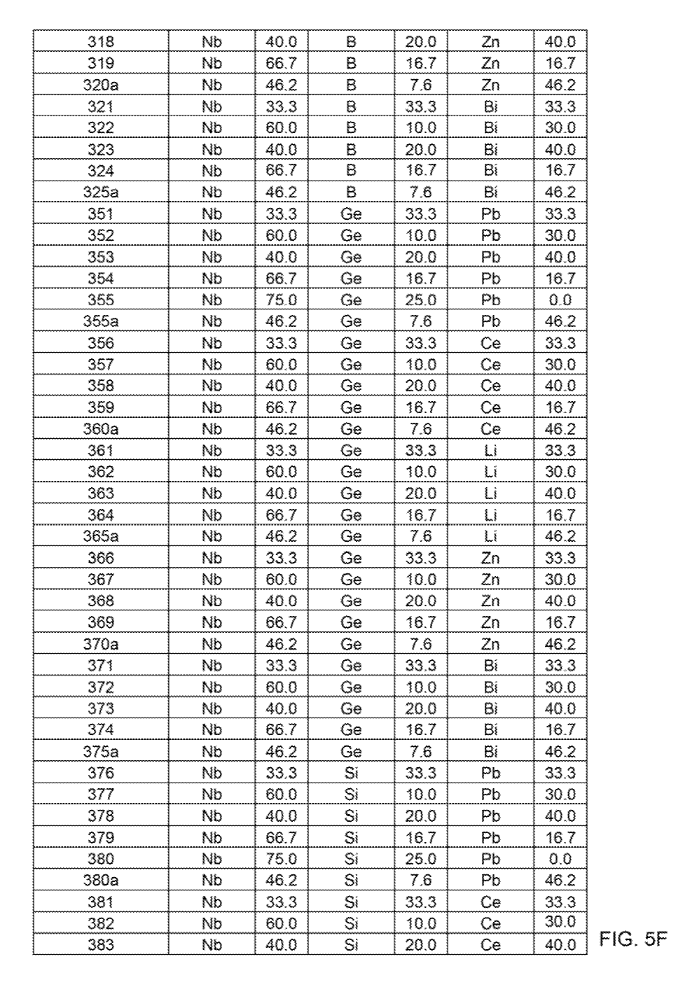

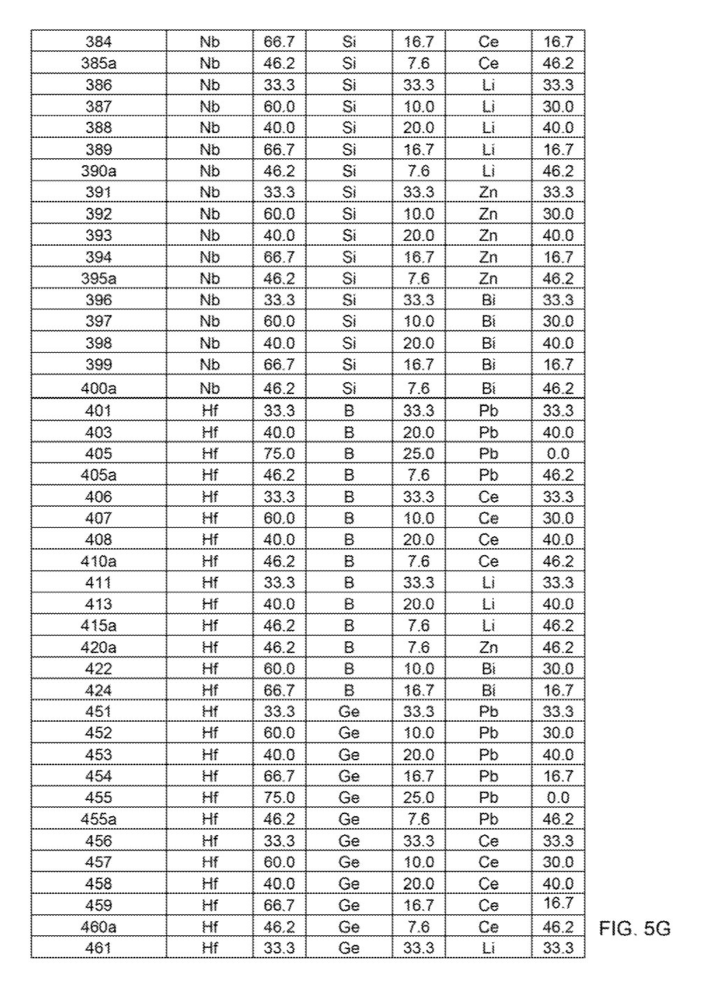

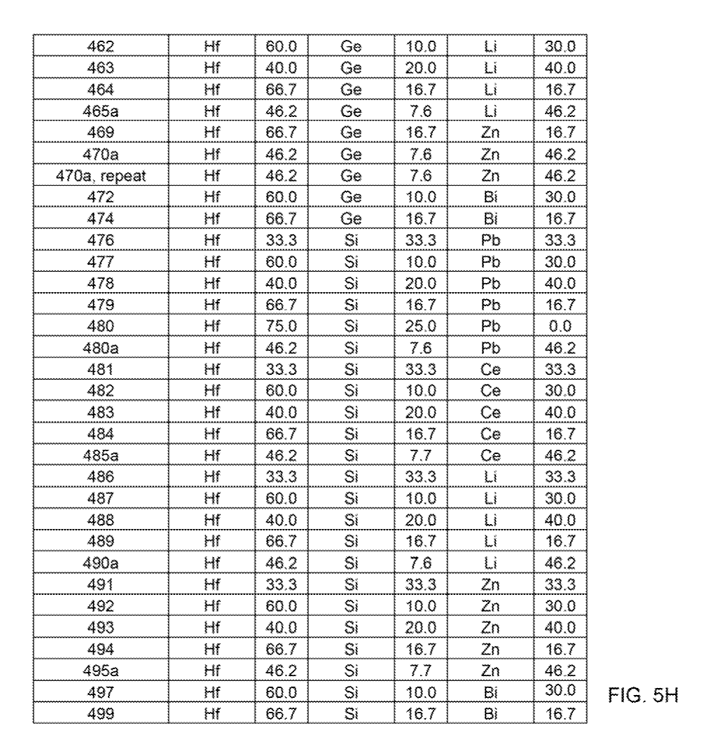

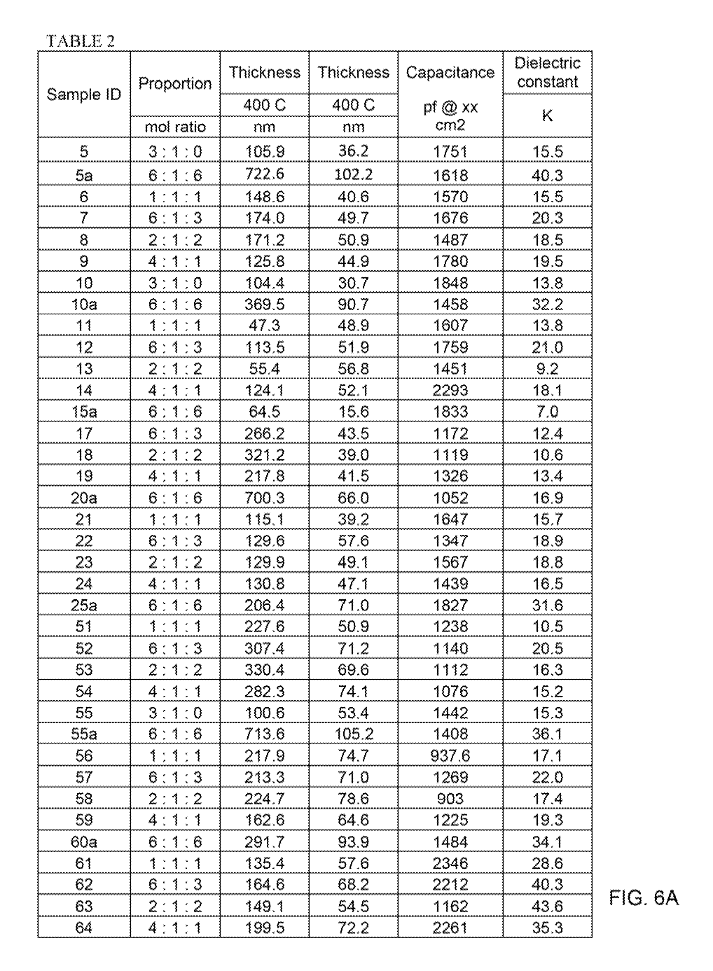

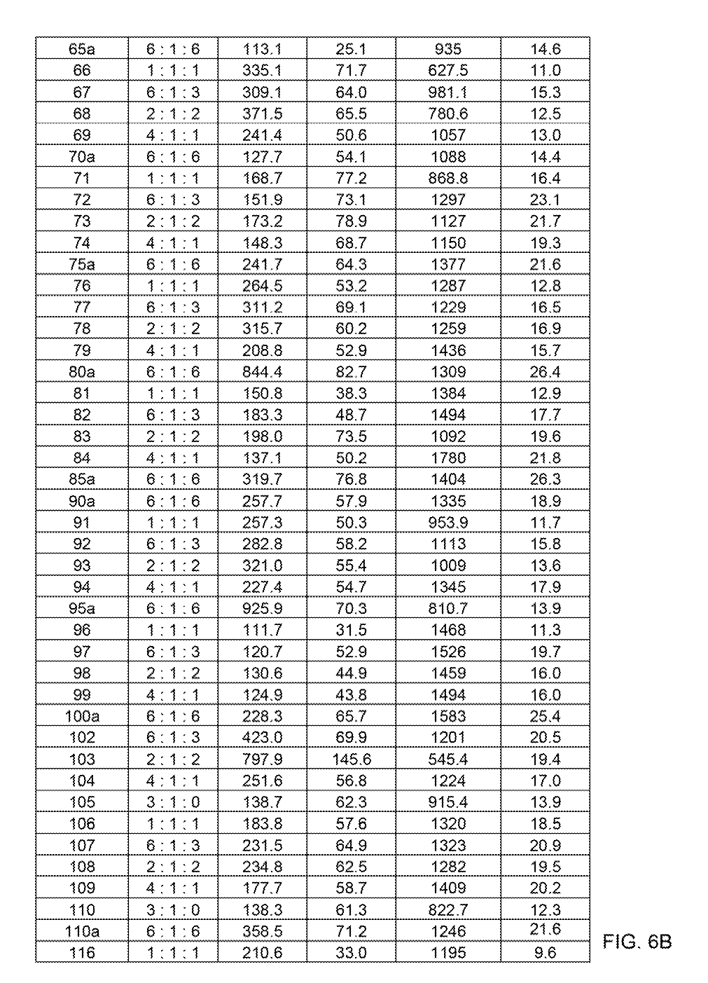

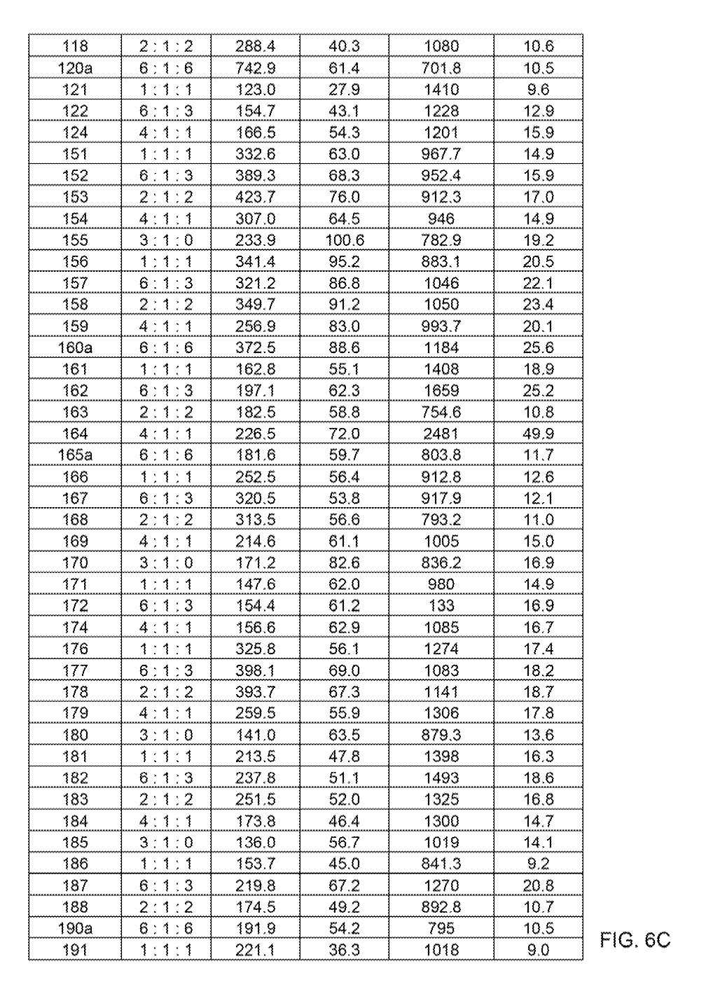

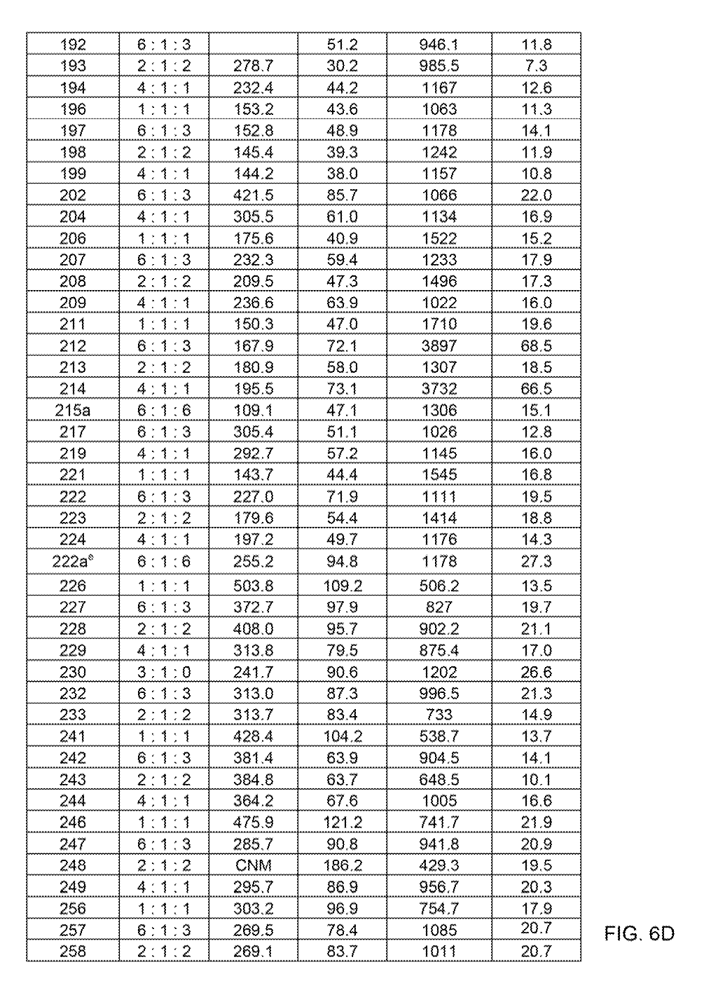

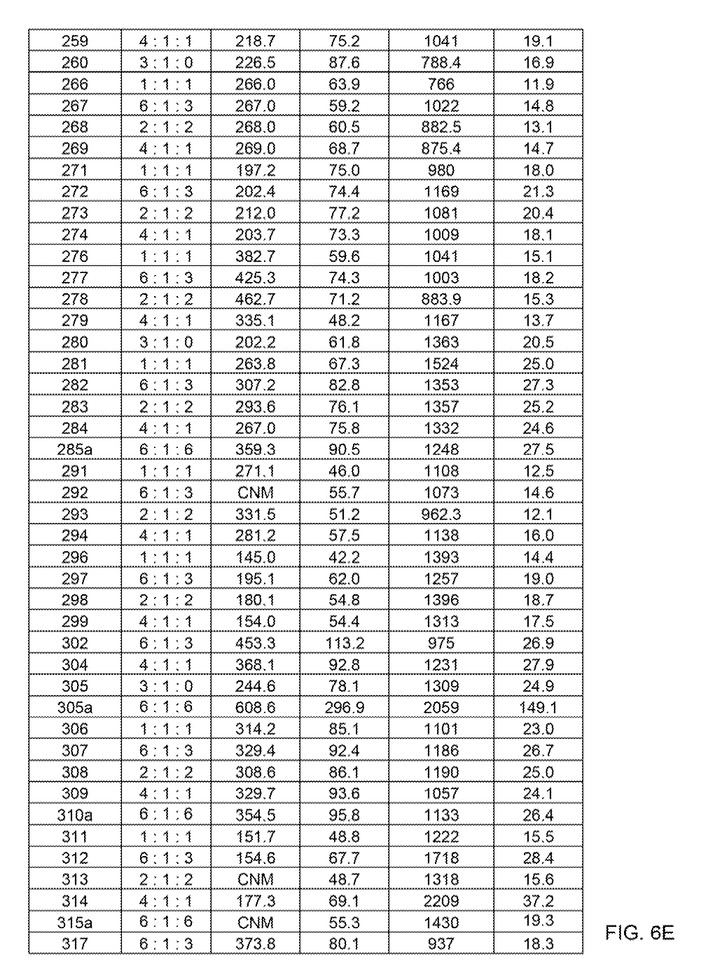

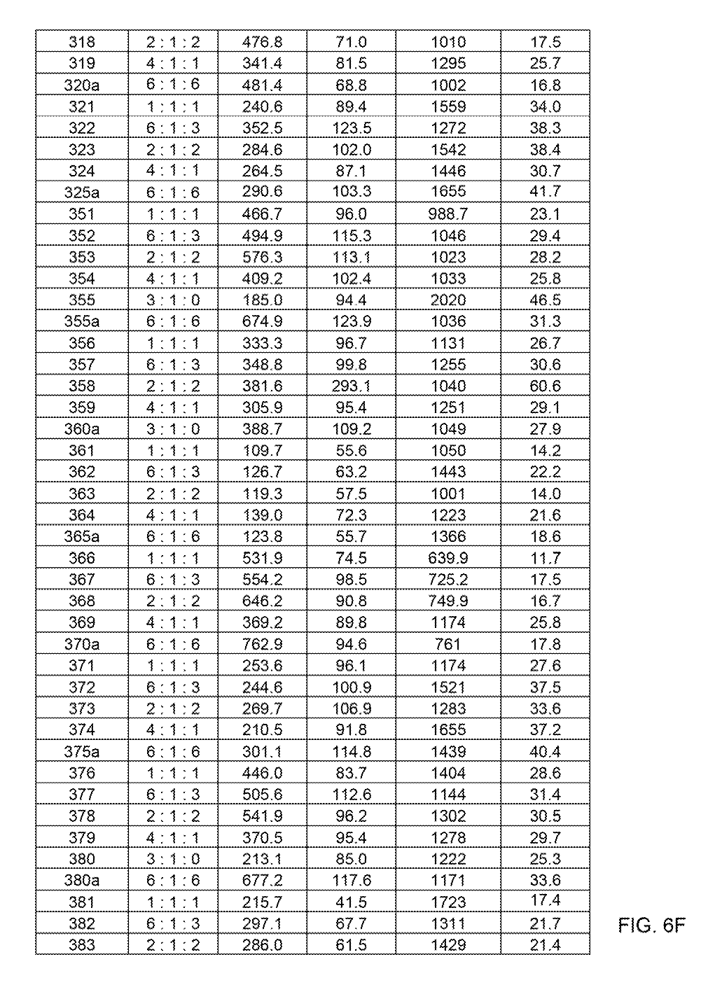

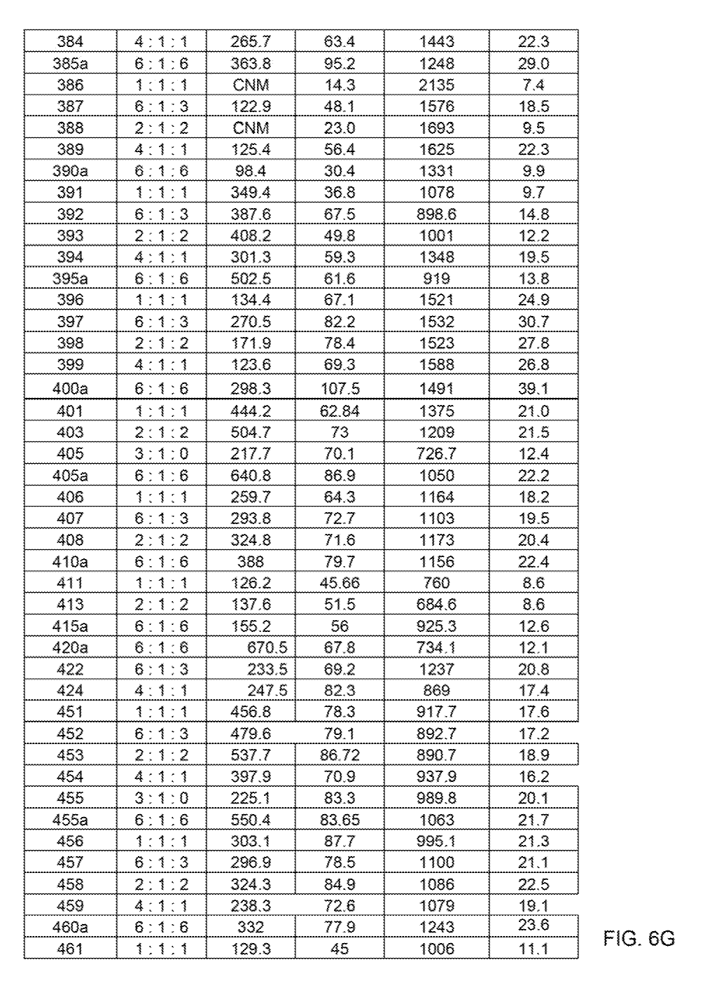

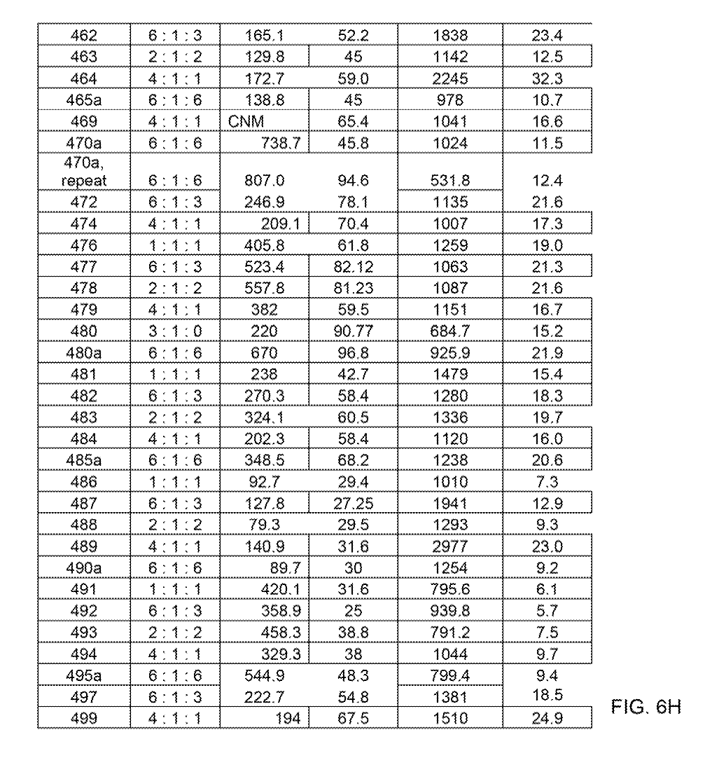

Further examples of dielectric oxide recipes are located in Table 1 (FIG. 5) and Table 2 (FIG. 6). Tables 1 and 2 refer to the same samples. In Table 1, the composition of each sample is defined by the atomic percents of the constituent oxide precursors with respect to the other oxide constituents. For example, sample 8 contains 40% Ti, 20% B, and 40% Ce, so that the final mole ratio in the oxide film after anneal would be 4 TiO₂:1 B₂O₃:2 Ce₂O₃. The atomic percents do not reflect other added components such as epoxide, solvent, or water

All samples in this example contained 1-methoxy-2-propanol as a solvent, 2,2-(ethoxy)ethoxyethanol as a cosolvent, and glycidyl isopropyl ether as the epoxide. Sols containing Li or Bi also contained acetic acid

All films were deposited by spin-coating at 1000 rpm for 90 s. Films were then soft-baked at 130° C. for 10 minutes, then annealed in air at 400° C. for 30 minutes.

The precursors used for various components were: titanium (IV) isopropoxide; tantalum (V) ethoxide; niobium (V) ethoxide; hafnium (IV) ethoxide; zirconium (IV) n-propoxide; boric acid; tetraethyl orthosilicate; germanium (IV) isopropoxide; phosphoric acid; lead perchlorate; cerium (III) nitrate; lithium acetate; zinc acetate; and bismuth (III) nitrate.

### Example 8

Ti_{0.4}B_{0.6}O_{1.7} Film

10 g 2-methoxyethanol and 22 g propylene oxide were mixed. 20 g of a solution of 28.5 g of titanium isopropoxide in 71.5 g 1-methoxyethanol was added, followed by 30 g of a solution of 14.7 g triethyl borate in 85.3 g 1-methoxyethanol. This sol was agitated at 22° C. overnight, filtered through a 0.1 um syringe filter and spun onto a glass coupon at 1000 rpm for 1 min. After a soft bake at 150° C. for 5 min., the coupon was annealed in air for 60 min. at 250° C. The resulting film was optically clear, with an oxide thickness (T_{OX}) of 98 nm. The refractive index 405 nm was 1.88, the Abbe No. was 26.0 and the absorbance was less than 1.0E-07.

### Example 9

Ti_{0.4}B_{0.6}O_{1.7} Film

2 g 2-methoxyethanol and 8.8 g glycidyl isopropyl ether were mixed. 4 g of a solution of 28.5 g of titanium isopropoxide in 71.5 g 1-methoxyethanol was added, followed by 6 g of a solution of 14.7 g triethyl borate in 85.3 g 1-methoxyethanol. This sol was agitated at 22° C. overnight, filtered through a 0.1 um syringe filter and spun onto a glass coupon at 1000 rpm for 1 min. After a soft bake at 150° C. for 5 min., the coupon was annealed in air for 15 min. at 400° C. The resulting film was optically clear, with an oxide thickness (T_{OX}) of 51.6 nm. The refractive index at 405 nm was 1.98, the Abbe No. was 15.7 and the absorbance was less than 1.0E-07.

### Example 10

Porous Ti_{0.4}B_{0.6}O_{1.7} Film

5.0 g of the sol made in Example 9 was combined with 0.2 g Brij 30, filtered as above and spun onto a glass coupon at 1000 rpm for 1 min. After a soft bake at 150° C. for 5 min., the coupon was annealed in air for 15 min. at 400° C. The resulting film was optically clear, with an oxide thickness (T_{OX}) of 59.0 nm. The refractive index at 405 nm was 1.86, the Abbe No. was 14.4 and the absorbance was less than 1.0E-07.

### Example 11

Nb_{0.6}B_{0.4}O_{2.9} Film

1 g 2-methoxyethanol and 2.2 g propylene oxide were mixed. 3.0 g of a 1 mol/kg solution of niobium ethoxide in 2-methoxyethanol and 2.0 g of a 1 mol/kg solution of boric acid in 1-methoxyethanol were added. This sol was agitated at 22° C. overnight, filtered through a 0.1 um syringe filter and spun onto a glass coupon at 1000 rpm for 1 min. After a soft bake at 150° C. for 5 min., the coupon was annealed in air for 10 min. at 240° C. The resulting film was optically clear, with an oxide thickness (T_{OX}) of 106.7 nm. The refractive index at 405 nm was 1.88. The absorbance was less than 1.0E-07.

### Example 12

Sn_{0.67}B_{0.33}O₂₋ₓ Film

1 g 2-methoxyethanol and 2.2 g propylene oxide were mixed. 4.0 g of a 0.5 mol/kg solution of SnCl₂ in 2-methoxyethanol and 1.0 g of a 1 mol/kg solution of triethyl borate in 1-methoxyethanol were added. This sol was agitated at 22° C. overnight, filtered through a 0.1 um syringe filter and spun onto a glass coupon at 1000 rpm for 1 min. After a soft bake at 150° C. for 5 min., the coupon was annealed in air for 15 min. at 400° C. The resulting film was optically clear, with an oxide thickness (T_{OX}) of 77.0 nm. The refractive index at 405 nm was 1.76. The absorbance was less than 1.0E-07. The Abbe No. was 24.1.

### Example 13

Ce_{0.8}B_{0.2}O₂₋ₓ Film

1 g 2-methoxyethanol and 2.2 g propylene oxide were mixed. 4.0 g of a 1 mol/kg solution of ceric ammonium nitrate in 2-methoxyethanol and 1.0 g of a 1 mol/kg solution of triethylborate in 1-methoxyethanol were added. This sol was agitated at 22° C. overnight, filtered through a 0.1 um syringe filter and spun onto a glass coupon at 1000 rpm for 1 min. After a soft bake at 150° C. for 5 min., the coupon was annealed in air for 15 min. at 400° C. The resulting film was slightly hazy, with an oxide thickness (T_{OX}) of 58.0 nm. The refractive index at 405 nm was 2.54. The Abbe No. is 5.2.

### Example 14

Th_{0.8}B_{0.2}O₂₋ₓ Film

1 g 2-methoxyethanol and 2.2 g propylene oxide were mixed. 4.0 g of a 1 mol/kg solution of thorium nitrate in methanol and 1.0 g of a 1 mol/kg solution of triethylborate in 1-methoxyethanol were added. This sol was agitated at 22° C. overnight, filtered through a 0.1 um syringe filter and spun onto a glass coupon at 1000 rpm for 1 min. After a soft bake at 150° C. for 5 min., the coupon was annealed in air for 15 min. at 400° C. The resulting film was slightly hazy, with an oxide thickness (T_{OX}) of 37.4 nm. The refractive index at 405 nm was 2.45. The Abbe No. is 22.5.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims.

What is claimed is:

1. A method of making a multilayer dielectric (MLD) film, comprising preparing at least one layer of the MLD film by
producing a sol from a mixture that comprises an epoxide and at least one precursor to a metal oxide,
depositing the sol on a substrate, and
preparing a metal oxide layer from the deposited sol.

2. The method of claim 1, wherein the at least one precursor is an alkoxide or salt of a transition metal, or is a transition metal ion combined with an inorganic or organic ligand.

3. The method of claim 1, wherein the at least one precursor is an alkoxide or salt of a main group metal.

4. The method of claim 1, wherein the at least one precursor is an alkoxide or salt of a lanthanide or actinide.

5. The method of claim 1, wherein the mixture further includes an alkoxide or salt of a main group nonmetal selected from the group consisting of B, Si, P, Ge, As, Se, and Te.

6. The method of claim 1, wherein the at least one precursor comprises two or more metal oxide precursors.

7. The method of claim 1, wherein the at least one precursor comprises a transition metal, a main group metal, a lanthanide, an actinide, or a combination thereof.

8. The method of claim 7, wherein the mixture further comprises a main group nonmetal.

9. The method of claim 1, wherein the mixture further comprises a solvent, water, a precursor to a glassforming oxide, at least one modifier, a cosolvent, or a porogen, or a combination thereof.

10. The method of claim 9, wherein the modifier is an alkoxide or salt of a transition metal, is a transition metal ion combined with an inorganic or organic ligand, or is a combination thereof, the glassforming oxide is SiO₂, B₂O₃, P₂O₅, GeO₂, As₂O₃, SeO₂, or TeO₂, and the porogen is a surfactant.

11. The method of claim 9, wherein the metal oxide layer comprises: a metal oxide or a mixture of metal and nonmetal oxides comprising a glassy phase; or nano-scale grains of crystalline oxide surrounded by a glassy phase.

12. The method of claim 11, wherein the glassy phase comprises a metal oxide or mixture of metal and nonmetal oxides forming a material having a preselected refractive index.

13. The method of claim 9, wherein the mixture includes at least the porogen such that the metal oxide layer is made porous.

14. The method of claim 13, wherein the porogen is a poly(ethylene oxide)-poly(propylene oxide)-poly(ethylene oxide) polymer, a polyoxyethylene alkyl ether, or a polyethylene glycol (n˜20) octadecyl ether.

15. The method of claim 1, wherein the metal oxide layer has a refractive index n of about 1.45 to about 2.6.

16. The method of claim 1, wherein the metal oxide layer has a dielectric constant in the range of 1.7 to 1.9 and has a thickness of approximately 100 nm.

17. The method of claim 16, wherein the dielectric constant is 1.8.

18. A method of making a multilayer dielectric (MLD) film, comprising preparing multiple layers of the MLD film by repeating the method of claim 1 to prepare each of the multiple layers, wherein the sols for producing the layers are the same or different.

19. A light emitting device comprising an MLD film prepared by the method of claim 1.
